(19) United States
(12) Patent Application Publication
(10) Pub. No.: US 2006/0178787 A1
(43) Pub. Date: Aug. 10, 2006

(54) Rear obstacle avoidance system for vehicle

(76) Inventor: Clark E. McCall, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/054,481

(22) Filed: Feb. 9, 2005

(51) Int. Cl. G06F 17/00

(52) U.S. Cl. 701/1; 701/49

(57) ABSTRACT

A rear obstacle detection system for use on a vehicle comprises a detector coupled to the vehicle for monitoring a region substantially to the rear of the vehicle when the vehicle is operating in reverse, at least one adjustable mirror assembly coupled to the vehicle, and a processor coupled to the detector and to the mirror assembly for adjusting the at least one adjustable mirror assembly when the vehicle is operating in reverse and an obstacle is detected within the region.

### FIELD OF THE INVENTION

The present invention relates generally to a rear obstacle avoidance system for use in a vehicle, and more particularly to a rear obstacle detection system wherein at least one rearview mirror assembly is adjusted in relation to obstacles near the rear of the vehicle.

### BACKGROUND OF THE INVENTION

In most circumstances, the driver of a vehicle (e.g. a car, truck, SUV, etc.) has adequate visibility to enable the safe operation of the vehicle. Furthermore, the driver's visibility is enhanced through the well-known use of interior and exterior rearview mirrors. Despite this, however, there are situations when a driver's visibility may be severely limited or eliminated. For example, when maneuvering a vehicle into a parking space between two other vehicles (i.e. when parallel parking), a driver is often required to perform one or more iterations of backing up and pulling forward between the two vehicles while attempting to avoid contact with either vehicle. In this situation, the driver oftentimes cannot see that portion of the vehicle that might make such contact. Another common situation wherein visibility may be limited occurs when a driver is backing a vehicle up (e.g. to a loading dock) to load or unload the vehicle or merely backing out of a garage.

A variety of rear vision and rear obstacle avoidance systems have been developed to help improve visibility in situations such as those described above. In general, these systems either (1) improve a driver's view of the rearward path, and/or (2) alert a driver that obstacles have been detected by a sensor (e.g. infrared, ultrasonic, or radar) monitoring the vehicle's rearward path. For example, to improve a driver's view of the rearward path, imaging systems have been developed that comprise a rear-facing camera mounted proximate the back of the vehicle, a reverse-gear sensor, and a display disposed within the vehicle's cabin and coupled to the camera. When the operator places the vehicle into a reverse mode, the reverse-gear sensor signals the display to begin showing images of the rearward path as captured by the camera. The driver may thus refer to the display to determine if any obstacles are present within the vehicle's projected rearward path.

Though image-based systems of the type just described may enable a driver to better monitor a vehicle's rearward path, such systems are relatively complicated and expensive. In contrast, a relatively inexpensive system that improves a driver's view of the rearward path utilizes motorized external rearview mirror assemblies, a processor, and a reverse gear sensor. In this system, the reverse gear sensor signals the processor when the vehicle is operating in reverse. The processor then instructs at least one external rearview mirror assembly to tilt its mirror downward by a predefined amount (i.e. the tilt angle) and thereby provide an improved view of the immediate rearward path and any obstacles therein.

Unfortunately, while mirror tilt systems of the type just described automatically tilt external rearview mirrors downward when a vehicle is placed in reverse, such mirror adjustments occur even when no obstacles are within or near the vehicle's rearward path. This may prevent a driver from using the mirror to view an area beyond that immediately behind the vehicle. Additionally, such systems may provide a less than optimal view of an obstacle because the external rearview mirrors are tilted downward by a predetermined set amount regardless of the distance between the vehicle and the rear obstacle.

It should thus be appreciated that it would be desirable to provide a rear obstacle avoidance system including external rearview mirrors that are adjusted only when an obstacle is within or near a vehicle's rearward path. It should further be appreciated that it would be desirable to provide such a system wherein the external rearview mirrors are adjusted automatically in accordance with the obstacle's specific location relative to the vehicle to optimize a driver's view of the obstacle.

### BRIEF SUMMARY OF THE INVENTION

According to an aspect of the invention, there is provided a rear obstacle detection system for use on a vehicle comprising a detector coupled to the vehicle for monitoring a region substantially to the rear of the vehicle when the vehicle is operating in reverse, at least one adjustable mirror assembly coupled to the vehicle, and a processor coupled to the detector and to the mirror assembly for adjusting the at least one adjustable mirror assembly when the vehicle is operating in reverse and an obstacle is detected within the region.

According to a further aspect of the invention, there is provided a rear obstacle detection system comprising a sensor for sensing when the vehicle is operating in reverse, an obstacle detector coupled to the sensor for monitoring a region to the rear of the vehicle when the vehicle is operating in reverse, and at least one adjustable external mirror assembly coupled to the vehicle. A processor is coupled to the sensor, the detector, and the mirror assembly for selectively placing the mirror assembly in one of a plurality of distance dependent mirror positions when an obstacle is detected in the region. The processor selects amongst the plurality of distance dependent mirror positions in accordance with the distance between the vehicle and the detected obstacle.

### BRIEF DESCRIPTION OF THE DRAWINGS

The present invention will hereinafter be described in conjunction with the following figures, wherein like reference numerals denote like elements, and:

FIG. 1 is a top view illustrating an exemplary embodiment of an inventive vehicular rear obstacle avoidance system;

FIG. 2 is a cutaway view of a motorized external rearview mirror suitable for use in conjunction with the present invention;

FIG. 3 is a side view of the vehicle shown in FIG. 1 illustrating a first mode of operation;

FIG. 4 is a side view of the vehicle shown in FIG. I illustrating a second mode of operation;

FIG. 5 is a side view of the external rearview mirror assembly shown in FIG. 4;

FIG. 6 is a flow chart illustrating a process that may be carried out by the rear obstacle avoidance system shown in FIG. 3; and

FIG. 7 is a top view of the vehicle shown in FIG. 1 illustrating a further embodiment of the present invention.

### DETAILED DESCRIPTION OF THE INVENTION

The following detailed description of the invention is merely exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

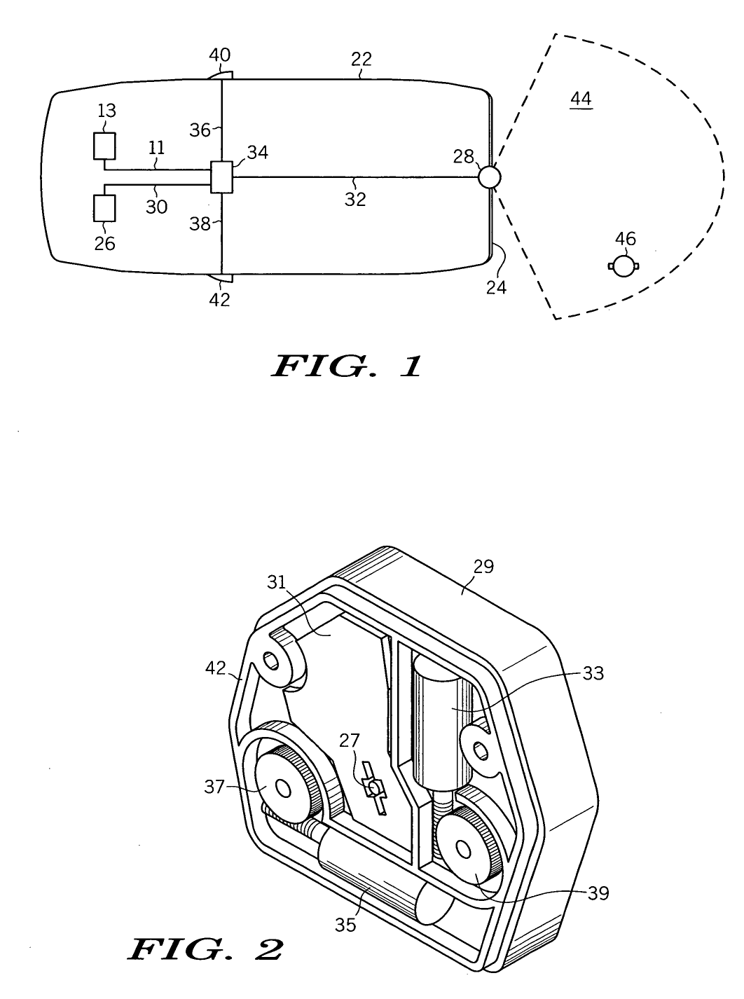

FIG. 1 is a top view of an exemplary embodiment of the inventive rear obstacle avoidance system deployed on a vehicle 22 having a rear bumper 24. The system comprises a reverse gear sensor 26 for detecting when vehicle 22 is operating in reverse (e.g. via the vehicle's PRNDL switch) and a rear obstacle detector 28. Sensor 26 and detector 28 are coupled by way of connections 30 and 32, respectively, to a processor 34, which is further coupled by way of connection II to a memory 13 and by way of connections 36 and 38 to adjustable external rearview mirror assemblies 40 and 42, respectively. Rear obstacle detector 28 comprises at least one sensor that searches for obstacles (e.g. obstacle 46 shown in FIG. 1) a detection field 44, which includes a portion of the rearward path that vehicle 22 may pass over when backing up. Rear obstacle detector 28 may monitor detection field 44 by, for example, transmitting energy pulses (e.g. infrared, ultrasonic, or radar) and receiving pulses reflected back from any obstacles to the rear of vehicle 22. Upon detection of an obstacle within field 44, detector 28 sends an OBSTACLE DETECTED signal and, perhaps, additional data, to processor 34 for processing. After processing the data provided by detector 28, processor 34 then causes one or more mirror assemblies (e.g. mirror assembly 42 and/or 40) to be adjusted as will be explained more fully hereinbelow.

FIG. 2 is an isometric view of a motorized rearview mirror assembly suitable for use as mirror assembly 42. As can be seen, mirror assembly 40 may comprise a housing 29 and two electrically operated motors, 33 and 35, which may turn two extendable elements 39 and 37, respectively. Elements 39 and 37 may be coupled to a mirror 31 (only partially shown in FIG. 2), which is pivotally coupled to housing 29 as shown at 27. Such power mirror assemblies are well-known in the automotive industry and further discussion is not deemed necessary at this time. However, the interested reader is referred to U.S. Pat. No. 4,733,957 issued Mar. 29, 1988, and entitled “Rearview Mirror Adjustable in Two Planes”; U.S. Pat. No. 4,324,454 issued Apr. 13, 1982, and entitled “Electric Mirror Angle Adjusting Device”; and U.S. Pat. No. 3,972,597 issued Aug. 3, 1976, and entitled “Electrically Adjustable Vehicle Rear View Mirror.”

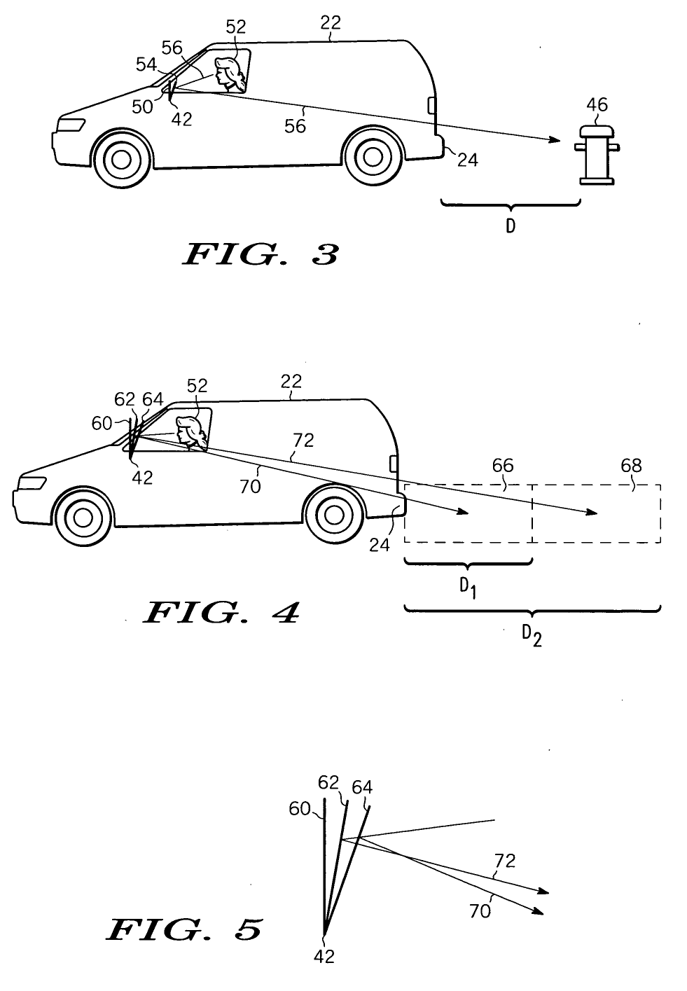

FIG. 3 is a side view illustrating a first mode of operation of the rear obstacle avoidance system in accordance with the present invention. In this embodiment, the tilt angle of at least one mirror assembly (i.e. the orientation of the mirror assembly's mirror about a substantially horizontal axis) is adjusted when (1) vehicle 22 is operating in reverse, and (2) rear obstacle detector 28 detects an obstacle within detection field 44 (FIG. 1). For example, the tilt angle of external rearview mirror assembly 42 may be adjusted to move mirror assembly 42 between a normal, operator-defined driving position 50 and an adjusted position 54, thus providing driver 52 with a view (as indicated in FIG. 3 by line of sight 56) that better shows an obstacle (e.g. obstacle 46) a distance D behind bumper 24. Thus, when backing up, driver 52 may utilize the external mirror assembly in its adjusted position to better view and avoid making contact rear obstacle 46.

To summarize the embodiment shown in FIG. 3 operates in the following manner. Referring to FIGS. 1 and 3, reverse gear sensor 26 alerts processor 34 that vehicle 22 has been placed in the reverse gear. Processor 34 then activates rear obstacle detector 28, which begins to monitor detection field 44. If and when an obstacle is detected within detection field 44, detector 28 sends an OBSTACLE DETECTED signal to processor 34, which then activates at least one external rearview mirror assembly (e.g. mirror assembly 42) to tilt its mirror downward by a predetermined tilt angle and into the adjusted position (e.g. 54). Mirror assembly 42 remains in this position until processor 34 receives (1) a signal from rear obstacle detector 28 indicating that obstacle 46 is no longer detected within detection field 44, or (2) reverse gear sensor 26 indicates that vehicle 22 is no longer operating in reverse. When either of these conditions occurs, processor 34 instructs mirror assembly 42 to tilt upward by the tilt angle and to thus return to operator-defined driving position 50.

FIG. 4 is a side view illustrating a second mode of operation of the rear obstacle avoidance system shown in FIG. 1. In this embodiment, the inventive rear obstacle avoidance system moves one or more external rearview mirrors (enlarged in FIG. 4 for clarity) between a plurality of positions depending on the distance between the vehicle and a rear obstacle (i.e. the detected distance) when the vehicle is operating in reverse. As shown in FIG. 4 and in greater detail in FIG. 5, adjustable external rearview mirror assembly 42 may be moved between three different positions (i.e. a driving position 60 and two adjusted positions, 62 and 64) in accordance with the detected distance. Though only three mirror positions are shown in FIG. 4, it should be clear to the skilled practitioner that any number of positions may be chosen to achieve a desired resolution. In this way, the inventive obstacle avoidance system may adjust mirror assembly 42 as vehicle 22 travels in reverse and nears an obstacle (e.g. a pole, curb, post, etc.) so as to continuously provide driver 52 with an optimal view of the approaching obstacle.

FIG. 4 shows two distinct areas or detection regions, 66 and 68, within detection field 44 (FIG. 1). Region 66 extends from bumper 24 to a first distance D₁ away therefrom, while region 68 extends between distance D₁ and distance D₂ away from bumper 24. The width of detection regions 66 and 68 may correspond to the width of detection field 44. To differentiate amongst distinct regions within detection field 44, rear obstacle detector 28 includes Distance Measurement Equipment capable of providing DME data indicating the distance between vehicle 22 and a detected obstacle (i.e. the detected distance). DME data comprises, for example, data related to the period of time required for a transmitted pulse to travel to and be reflected back from an object. Processor 34 utilizes such DME data to determine the detected distance and adjust at least one mirror assembly (e.g. mirror assembly 42) in accordance therewith. Vehicular rear obstacle detection systems capable of providing DME data are well-known. For example, U.S. Pat. No. 4,903,004 issued Feb. 20, 1990, and entitled “All-Weather Digital Distance Measuring and Signaling System” describes a vehicular distance measuring and signaling system specifically intended for accurately measuring distances separating a vehicle from rear obstructions. Another example of a rear obstacle detection systems capable of producing DME data is provided by U.S. Pat. No. 4,674,073 issued Jun. 16, 1987, and entitled “Reflective Object Detecting Apparatus,” which describes an apparatus wherein a plurality of ultrasonic transmitting elements and ultrasonic receiving elements are provided and are electrically switched in a sequential manner to allow the existence of an obstacle to be detected.

As stated above, mirror assembly 42 may be moved between at least three positions: (1) a normal driving position 60, (2) a first adjusted position 62, and (3) a second adjusted position 64. The inventive obstacle avoidance system is configured to move mirror assembly 42 between these three positions when vehicle 22 is operating in reverse. It should be self-evident that, as mirror assembly 42 tilts downward, the viewing area provided thereby moves increasingly closer to the rear of vehicle 22. For this reason, it is desirable to increase the tilt angle of mirror assembly as the detected distance of the obstacle decreases. Processor 34 processes DME data by means of, for example, a look-up table to determine a corresponding mirror assembly adjustment. As suggested in FIGS. 4 and 5, mirror assembly 42 may be placed in adjusted position 62 when an obstacle is detected within region 68 (i.e. between D₁ and D₂ feet behind vehicle 22) to provide an improved view of region 68 and its contents (as indicated in FIGS. 4 and 5 by line of sight 72). Similarly, mirror assembly 42 may be placed in position 64 when an obstacle is detected within region 66 (i.e. within D₁ feet of bumper 24) to provide an improved view of region 66 and its contents (e.g. as indicated in FIGS. 4 and 5 by line of sight 70). When an obstacle is not detected within region 66 or 68, or when vehicle 22 is not operating in reverse, mirror assembly 42 is placed in normal driving position 60.

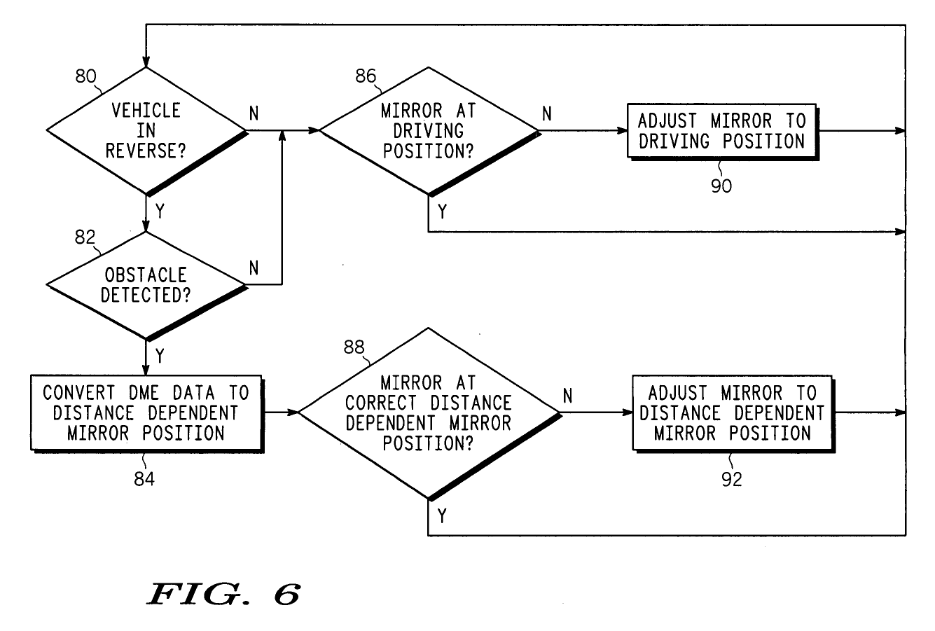

FIG. 6 is a flowchart illustrating a process suitable for implementing mirror assembly adjustments such as those described above. Referring to FIGS. 1 and 4-6, processor 34 first determines if vehicle 22 is operating in reverse (shown at 80). If vehicle 22 is not operating in reverse, processor 34 determines if mirror assembly 42 is in normal driving position 60 (shown at 86). If mirror assembly 42 is in driving position 60, processor 34 returns to STEP 80. If mirror assembly 42 is not in the normal driving position, processor 34 moves mirror assembly 42 to driving position 60. If it is determined during STEP 80 that vehicle 22 is operating in reverse, processor 34 establishes whether an OBSTACLE DETECTED signal is being received from detector 28 (shown at 82). If no such signal is received, processor 34 returns to STEP 80. If, however, an OBSTACLE DETECTED signal is received, processor 34 utilizes the corresponding DME data to determine the appropriate mirror assembly position (i.e. the Distance Dependent Mirror Position or DDM position) as shown at 84.

As stated above, processor 34 determines the appropriate mirror assembly DDM position by processing DME data to determine the detected distance and the appropriate tilt angle (e g. through the use of a look-up table). For example, if the detected distance is determined to be within D₁ feet of bumper 24, between D₁ and D₂ feet away from bumper 24, or beyond D₂ feet of bumper 24, processor 34 may refer to a look-up table to determine the appropriate DDM position to be position 64, 62, or 60, respectively.

Referring still to FIGS. 1 and 4-6, after accessing the appropriate mirror assembly position, processor 34 determines if mirror assembly 42 is currently in the correct DDM position (shown at 88). If mirror assembly 42 is in the correct DDM position, processor 34 returns to STEP 80. Conversely, if mirror assembly 42 is not in the correct DDM position (shown at 74), then processor 34 causes assembly 42 to be moved into the correct DDM position (shown at 92). When vehicle 22 is taken out of reverse, the inventive system returns mirror assembly 42 to its normal driving position (e.g. position 60), if necessary (as shown at 90). That is, after vehicle 22 is taken out of reverse as indicated by reverse gear sensor 26 (as determined in STEP 80), processor 34 determines if mirror assembly 42 is currently in driving position 60 (shown at 86). If the mirror assembly is not currently in the driving position, processor 34 instructs mirror assembly 42 to adjust to driving position 60 (shown at 92).

To further illustrate, assume that vehicle 22 is operating in reverse and that an obstacle is currently within detection region 68 (FIG. 4). After the obstacle is detected by rear obstacle detector 28 (shown at 82), processor 34 utilizes current DME data to determine the detected distance, which is then converted to the appropriate DDM position. For example, processor 34 may first determine that the current detected distance places the obstacle within region 68, and then extract from a memory associated with processor 34 the corresponding DDM position; i.e. DDM position 62 (shown at 84). Next, processor 34 determines if mirror assembly 42 is in this DDM position (shown at 88) and, if assembly 42 is not, processor 34 instructs mirror assembly 42 to adjust to DDM position 62.

Assume now that the vehicle 22 has moved backwards such that the obstacle has moved closer to bumper 24 and into region 66. Processor 34 now utilizes updated DME data to determine that the obstacle is within D₁ of bumper 24. Processor 34 coverts this detected distance into a corresponding DDM position, such as position 64, in the manner described above (STEP 84). If the mirror assembly is not already in this position (determined in STEP 88), processor 34 causes mirror assembly 42 to be repositioned at position 64 (shown at 92).

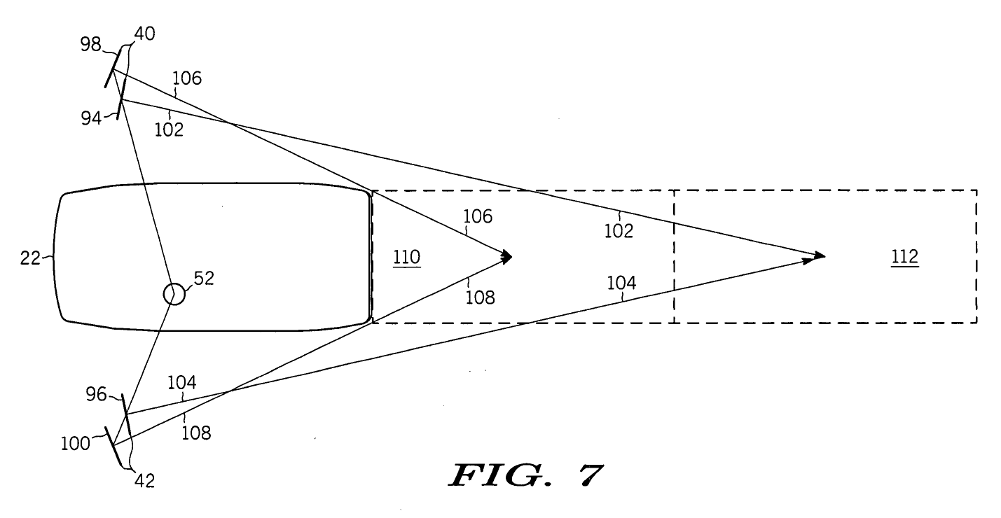

FIG. 7 is a top view illustrating yet another embodiment of the inventive obstacle avoidance system. In this embodiment, as in the embodiment shown in FIGS. 4 and 5, the inventive rear obstacle avoidance system moves one or more external rearview mirror assemblies (enlarged in FIG. 7 for clarity) between a plurality of positions in accordance with the detected distance. For example, first and second mirror assemblies 40 and 42 may each be adjusted between one respective driving position (not shown in FIG. 7 for clarity), and, for example, two respective adjusted positions (i.e. 94 and 96, or 98 and 100, respectively). The adjusted positions may differ from one another in two ways: (1) by transverse angle (i.e. the orientation of the mirror of a mirror assembly about a substantially vertical axis), and (2) by lateral mirror assembly extension (i.e. the distance separating the mirror assembly from the vehicle's side). Extendable mirror assemblies suitable for use as mirror assemblies 40 and 42 are known in the art and are described generally in U.S. Pat. No. 6,497,491 issued Dec. 24, 2002, and entitled “Extendable Mirror.” If desired, side-mounted sensors may be utilized to indicate the presence of any obstacles to the sides of the vehicle (e.g. a garage wall) that the mirror assemblies might contact when extending.

It should be fairly obvious that, as the mirror assemblies extend outward and/or tilt inward, the viewing areas provided thereby move increasingly closer to the rear of vehicle 22. For this reason, it is desirable to increase mirror assembly extension and/or decrease transverse angle (such that the mirror assembly tilts inward) as the detected distance decreases. For example, mirror assemblies 40 and 42 may be extended and tilted inward (i.e. toward vehicle 22) relative to their normal driving positions in positions 94 and 96, respectively, to provide viewing areas which include detection region 112 (as indicated in FIG. 7 by lines of sight 102 and 104, respectively). Mirror assemblies 40 and 42 may be further extend and further tilted inward relative to their normal driving positions in positions 98 and 100, respectively, to provide viewing areas which include detection region 110 (as indicated in FIG. 7 by lines of sight 106 and 108, respectively).

The embodiment depicted in FIG. 7 operates in much the same way as does the embodiment depicted in FIGS. 4 and 5. That is, when driver 52 places vehicle 22 in reverse, reverse gear sensor 26 signals processor 34, which then signals rear obstacle detector 28 to monitor detection field 44. If an obstacle is detected within detection field 44, detector 28 sends the above described OBSTACLE DETECTED signal and accompanying DME data to processor 34, which then utilizes the DME data to determine first and second corresponding DDM positions in which mirror assemblies 40 and 42, respectively, should be placed. Processor 34 may implement the appropriate DDM positions by way of the process described in connection with FIG. 6. As this process has been described in detail hereinabove, no further discussion is deemed necessary at this time.

It should thus be appreciated from the foregoing that there has been provided a rear obstacle avoidance system that adjusts at least one rearview mirror when a vehicle is operating in reverse and an obstacle is within or near a vehicle's rearward path. It should further be appreciated that a system has been provided wherein at least one rearview mirror is adjusted in accordance with the specific location of a rear obstacle so as to optimize a driver's view of that obstacle. Though embodiments of the inventive rear obstacle avoidance system have been described hereinabove as adjusting either (1) the tilt angle of at least one mirror assembly, or (2) the transverse angle of at least one mirror assembly and mirror assembly extension, it should be understood that the mirror assemblies adjusted in any number of ways or combination thereof. Furthermore, while a relatively few number of mirror assembly positions have been shown, it should be understood that any number of positions may be employed to achieve a desired resolution.

While a limited number of exemplary embodiments have been presented in the foregoing detailed description, it should be appreciated that a vast number of variations exist.

For example, the entire rear obstacle avoidance system could be electronic; that is, comprised of cameras and displays. Automatic zooming could be provided to fill the display frame with the detected object and/or the detected object could be highlighted on the display screen. A more sophisticated mirror assembly could be employed to annotate the detected image in the mirror. A processor could be employed to steer a mirror right or left in response to moving the steering wheel to the right or left. Head and eye position tracking could be utilized to more accurately position the mirror. Finally, the system could be extended to detected objects to the side of the vehicle during forward motion. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiments. Various changes can be made in the function and arrangement of elements without departing from the scope of the invention as set forth in the appended claims and the legal equivalents thereof.

What is claimed is:

1. A rear obstacle detection system for use on a vehicle, the system comprising:
a detector coupled to the vehicle for monitoring a region substantially to the rear of the vehicle when the vehicle is operating in reverse;
at least one adjustable mirror assembly coupled to the vehicle; and
a processor coupled to said detector and to said at least one adjustable mirror assembly for adjusting said at least one adjustable mirror assembly when the vehicle is operating in reverse and an obstacle is detected within said region.

2. A rear obstacle detection system according to claim 1 further comprising a sensor coupled to said processor for sensing when the vehicle is operating in reverse.

3. A rear obstacle detection system according to claim 2 wherein said at least one adjustable mirror assembly is an external mirror assembly.

4. A rear obstacle detection system according to claim 1 wherein said processor is further configured to return said at least one adjustable mirror assembly to a normal driving position when said vehicle is no longer operating in reverse.

5. A rear obstacle detection system according to claim 4 wherein said detector further comprises distance measuring equipment.

6. A rear obstacle detection system according to claim 5 wherein said processor adjusts said at least one adjustable mirror assembly in accordance with the data received from said distance measuring equipment.

7. A rear obstacle detection system according to claim 6 wherein said processor processes data from said distance measuring equipment and determines therefrom which mirror position should be selected from a plurality of mirror positions.

8. A rear obstacle detection system according to claim 6 wherein said mirror assembly comprises at least one mirror and wherein said processor is configured to tilt said mirror about a substantially horizontal axis.

9. A rear obstacle detection system according to claim 6 wherein said processor is configured to adjust a transverse angle of said at least one adjustable mirror assembly about a substantially vertical axis.

10. A rear obstacle detection system according to claim 6 wherein said processor is further configured to adjust the distance of said at least one adjustable mirror assembly from said vehicle.

11. A rear obstacle detection system according to claim 10 further comprising a lateral-facing sensor coupled to said processor for detecting objects proximate said at least one adjustable mirror assembly.

12. A rear obstacle detection system for use on a vehicle, the system comprising:
a detector coupled to the vehicle for monitoring a region substantially to the rear of the vehicle when the vehicle is operating in reverse;
at least one adjustable mirror mounted on the vehicle and capable of being placed into a normal driving position and a tilted down position;
a sensor means for indicating when the vehicle is in reverse; and
a processor coupled to said detector, said adjustable mirror, and said sensor means for placing said mirror in said titled down position only when the vehicle is in reverse and an obstacle is detected in said region.

13. A rear obstacle detection system according to claim 12 wherein said processor is configured to return said mirror to said normal driving position when said vehicle is not operating in reverse.

14. A rear obstacle detection system according to claim 13 further comprising a sensor coupled to said processor for indicating when the vehicle is placed in reverse.

15. A rear obstacle detection system according to claim 14 wherein said detector comprises distance measuring equipment.

16. A rear obstacle detection system according to claim 15 wherein said mirror is an external rearview mirror.

17. A rear obstacle detection system, comprising:
a sensor for sensing when the vehicle is operating in reverse;
an obstacle detector coupled to said sensor for monitoring a region to the rear of the vehicle when the vehicle is operating in reverse;
at least one adjustable external mirror assembly coupled to the vehicle; and
a processor coupled to said sensor, said detector, and said at least one adjustable mirror assembly for selectively placing said at least one adjustable mirror assembly in one of a plurality of distance dependent mirror positions when an obstacle is detected in said region, said processor selecting amongst said plurality of distance dependent mirror positions in accordance with the distance between the vehicle and the detected obstacle.

18. A rear obstacle detection system according to claim 17 wherein said processor is configured to tilt the mirror of said at least one adjustable external mirror assembly about a substantially horizontal axis.

19. A rear obstacle detection system according to claim 18 wherein said processor is configured to adjust the transverse angle of the mirror of said at least one adjustable external mirror assembly about a substantially vertical axis.

20. A rear obstacle detection system according to claim 19 wherein said processor is further configured to adjust the distance between said at least one adjustable external mirror assembly and said vehicle.
